(19) United States
(12) Patent Application Publication
(10) Pub. No.: US 2019/0199837 A1
(43) Pub. Date: Jun. 27, 2019

(54) MOBILE DEVICE RETAINING SYSTEM AND RELATED METHODS

(71) Applicant: Adrian E. McPhaul, Fillmore, UT (US)

(72) Inventor: Adrian E. McPhaul, Fillmore, UT (US)

(21) Appl. No.: 16/226,327

(22) Filed: Dec. 19, 2018

Related U.S. Application Data
(60) Provisional application No. 62/609,194, filed on Dec. 21, 2017.

(51) Int. Cl. H04M 1/02; A44B 18/00; A41D 1/00

(52) U.S. Cl. CPC H04M 1/026; A41D 2300/20; A41D 1/002; A44B 18/0046

(57) ABSTRACT

The present disclosure is directed to systems and methods for removably securing a mobile device to an item of clothing worn by a user and to methods of using and making such systems. An insert member has a fastener, such as a hook and loop material, disposed thereon. The insert member is placed outside the article of clothing, and a retaining clip is placed inside the article of clothing. The insert member is then secured in the retaining clip with the fabric held therebetween. The fastener is then accessibly secured at a suitable location on a user's body for accessing when in a seated position without requiring standing. A counterpart fastener attached to a case of the mobile device may then be used to secure the device to the insert member. The device may then be accessed and actuated for use without requiring standing.

### CROSS-REFERENCE TO RELATED APPLICATIONS

This application claims the benefit of U.S. Provisional Application No. 62/609,194, filed Dec. 21, 2017, which is hereby incorporated by reference herein in its entirety, including but not limited to those portions that specifically appear hereinafter.

### BACKGROUND

Attempts to carry a mobile device without using a pocket have generally resulted in belt mounted clips. These typically make the device somewhat cumbersome and difficult to carry by always snagging and being “in the way.” In addition, they are nearly impossible to use with speaker phone features and can be inaccessible in a seated position while active, as when riding a horse. A mounting system that allowed a mobile device to be attached to a standard clothing item in a position where it can be easily accessed, and where features such as “speakerphone” can be utilized would be an improvement in the art.

### SUMMARY

The present disclosure is directed to systems and methods for removably securing a mobile device to an item of clothing worn by a user and to methods of using and making such systems. An insert member has a fastener, such as a hook and loop material, disposed thereon. The insert member is placed outside the article of clothing, and a retaining clip is placed inside the article of clothing. The insert member is then secured in the retaining clip with the fabric held therebetween. The fastener is then accessibly secured at a suitable location on a user's body for accessing when in a seated position without requiring standing.

A counterpart fastener attached to a case of the mobile device may then be used to secure the device to the insert member. The device may then be accessed and actuated for use without requiring standing. For example, where the system is used to secure a cellular phone to a user's shirt or jacket near a shoulder portion, a user can easily access the phone from a sitting position or use it in a “speakerphone” mode while it remains secured.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIGS. 1 and 1A are top and side views, respectively of various components of a first illustrative embodiment of a mobile device securing system in accordance with the teachings of the present disclosure, in an unassembled and an assembled conformation.

FIG. 1B is a top view of various components of a second illustrative embodiment of a mobile device securing system in accordance with the teachings of the present disclosure, in an unassembled conformation.

FIGS. 2 and 3 are back and front views, respectively, of the embodiment of FIG. 1 secured to a portion of a textile item of clothing, such as a shirt.

FIG. 4 depicts the embodiment of FIG. 1 secured to a portion of a textile item of clothing 3 worn by a user to place the system at a desirable position on the user's body.

FIG. 5 depicts a mobile device secured to an item of clothing worn by a user and allowing use thereof using a system similar to that depicted in FIG. 1.

### DETAILED DESCRIPTION

The disclosure extends to methods, systems, and products for securing a mobile device in a position and manner that allow to be used in a sitting position, especially in a hands-free manner. In the following description of the disclosure, reference is made to the accompanying drawings, which form a part hereof, and in which is shown by way of illustration specific implementations in which the disclosure is may be practiced. It will be appreciated by those skilled in the art that the embodiments herein described, while illustrative, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

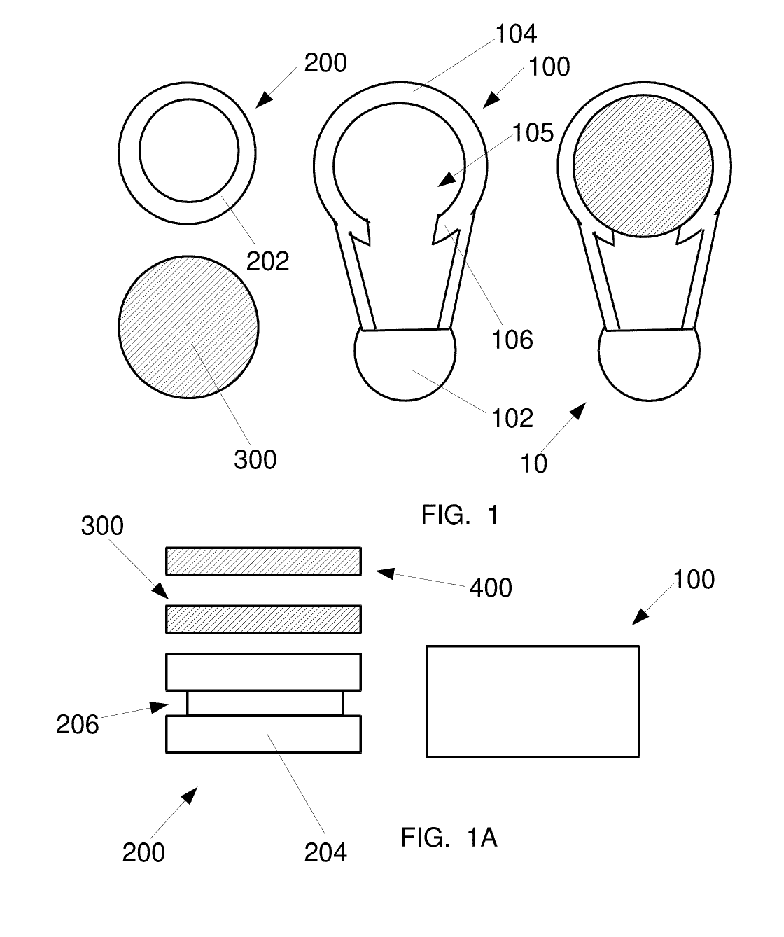

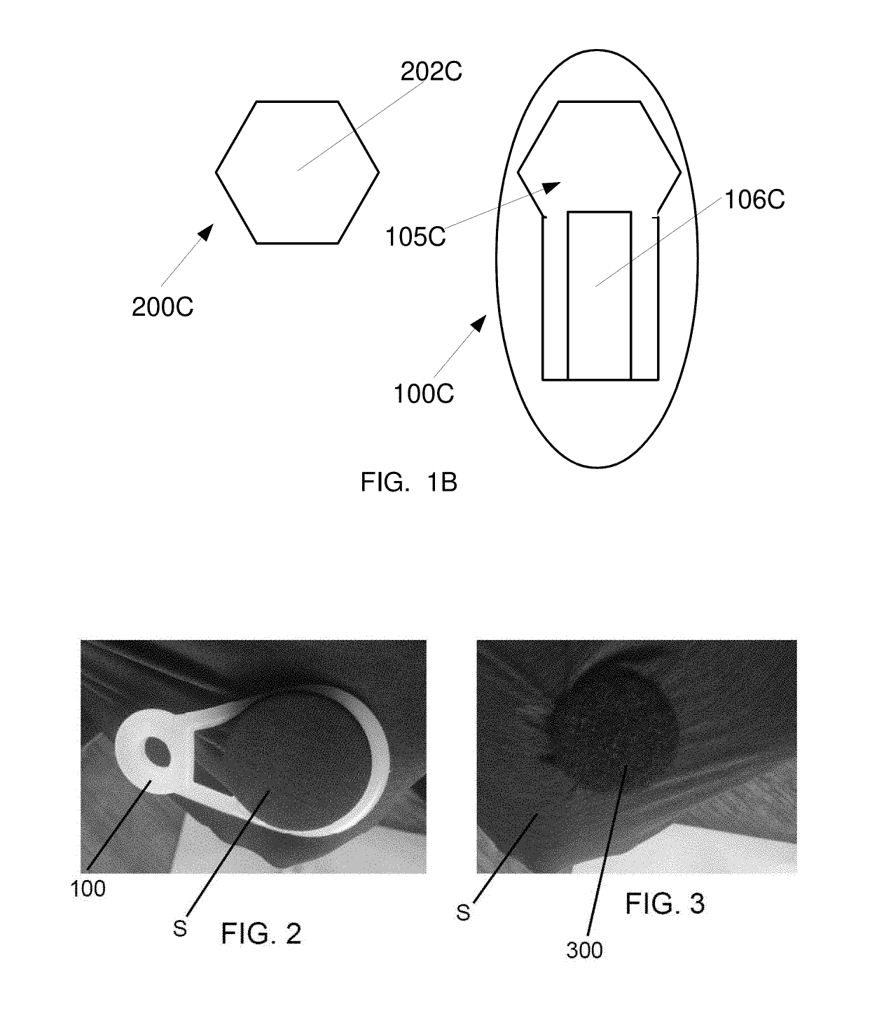

Turning to FIGS. 1, 1A, and 2 through 4, a first embodiment of a mobile device securing system 10 in accordance with the present disclosure is depicted. System 10 includes an insert member 200, which may be formed as a member having upper and lower planar areas, and a sidewall 204 with an inset groove 206. In the depicted embodiment, the member may be formed as a circular disc with a surrounding grooved sidewall. It will be appreciated that for certain other embodiments, it may have differing shapes as may be suitable for particular uses. As depicted, the insert member may be hollow or include insets to reduce materials used or may be a solid member.

A fastener, such as a hook and loop fastener 300, may be disposed on an upper surface of the insert 200. As depicted, this may be accomplished by using a hook and loop material, such as Velcro™ that is adhered with a suitable adhesive. It will be appreciated that in addition to hook and loop fasteners, that other suitable fasteners may be used. For example, a suitable releasable adhesive could be disposed on the fastening surface of the insert member, or a receiver for a “snap” type fastener may be disposed on, or formed in, the insert member 200. In some embodiments, the insert member 200 could be permanently affixed to a case for a mobile device.

A retaining clip 100, may include an insert portion 104 with a space 105 for receiving the insert member 200. As depicted, space 105 may be defined by a surrounding sidewall, including tabs 106, which is sized to be received in the groove 206 of the insert member 200. A gap in a portion of the sidewall (between tabs 106) may facilitate the insertion and removal of the insert member 200. The retaining clip 100 may further include an extended portion 102 to facilitate handling during installation of the insert member 200. The insert member 200 and retaining clip 100 may be constructed of plastic materials to have sufficient flexibility for installation and removal. For some embodiments, the retaining clip and insert member could be adapted from commercially available tarp clips such as those available from Cameo as the Cameo 51344 Tarp Clip.

It will be appreciated that although insert member 200 is depicted as having a generally rounded columnar shape and insert portion 104 of retaining clip 100 having a corresponding shape, that other shapes are contemplated with the scope of the present disclosure. For example, as depicted in FIG. 1B, an insert member 200C having a planar top 202C for secure attachment to fastener 300 may have a polygonal shape, such as triangular, rectangular, pentagonal, hexagonal, octagonal and the like. Retaining clip 100C may have an insert portion 104C with a corresponding shape. Such polygonal insert members 200C may be more resistant to rotating when seated in the retaining claim 100C during use. It is noted that instead of tabs 106, the retaining clip 100C, as depicted, features a locking member 106C, which may be formed as an elongated member attached to the body of the clip 100C at a first end, with a distal connection end extending into the insert portion 104C. For connection and removal, the distal connection end of the locking member 106C may be flexibly inserted into or removed from the insert groove of the insertion member 200C. It will be appreciated that the depicted connections are only illustrative and that other abuttable or slidable connections for securing the insert member within the clip may be used in accordance with the present disclosure.

For use, as depicted in FIGS. 2 through 5, the insert member 200 may be placed outside an article of clothing, such as a shirt S or a jacket. The fastener 300 should be facing away from the clothing exterior. The retaining clip 100 is placed inside the article of clothing and the insert member 200 is secured in the retaining clip as the member 200 is inserted into the space 105 such that the sidewall (including a portion of tabs 106) resides in groove 206, with the fabric of the clothing item (such as a shirt) S held therebetween. As depicted, the fastener 300 is then accessible on the exterior of the clothing S.

A counterpart fastener 400 (FIG. 1B) attached to a case of the mobile device P may then be used to secure the device to fastener 300 on the insert member 200. It will be appreciated that counterpart fastener 400 may be a hook and loop material, such as Velcro™ that is adhered with a suitable adhesive, or may be another suitable fastener for attachment to the fastener 300.

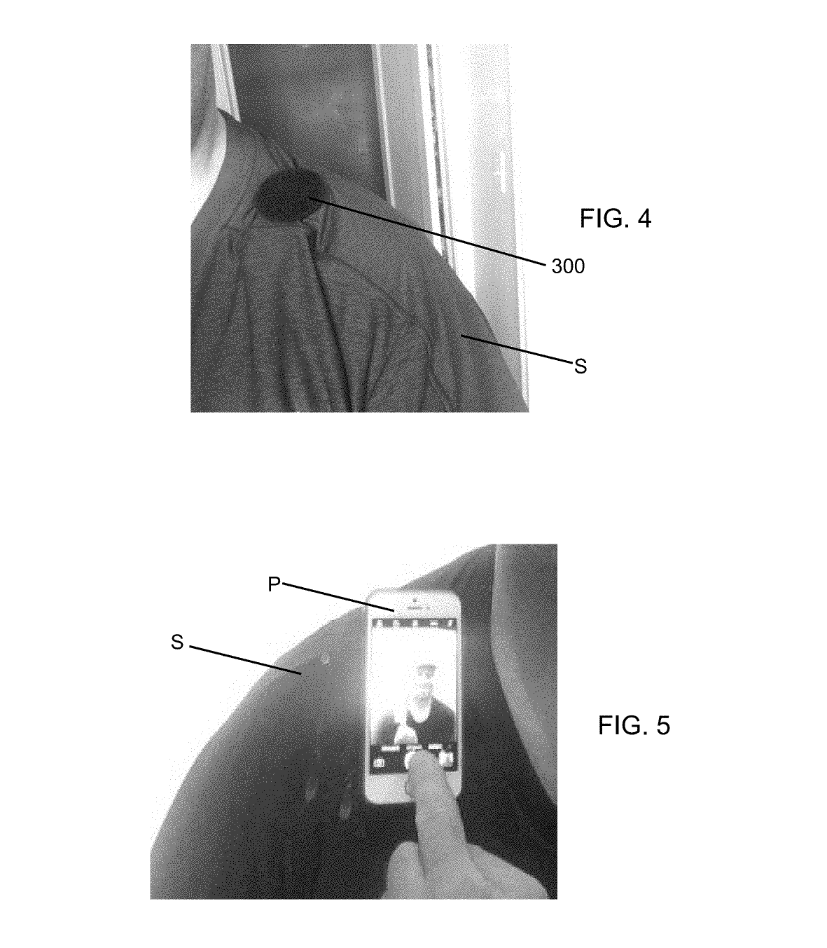

As depicted in FIGS. 4 and 5, where the system 10 is used to secure a cellular phone to a user's shirt or jacket near a shoulder portion, a user can easily access the phone from a sitting position or use it in a “speakerphone” mode while it remains secured. This allows for use while riding a horse or engaging in other activities and keeping the user's hands free as may be needed.

It will be appreciated that the present disclosure includes methods of making and methods of using systems in accordance with this disclosure. One such illustrative method includes obtaining a system in accordance with this disclosure. A user may then position an insert member of the system on the exterior of an item of clothing, at a position that will correspond to a portion of the user's body which is easily accessible by a single hand when in a sitting position. Such positions may include the front of a shoulder or the upper chest, among others. A fastener disposed on the insert member or the fastening surface of the insert member faces away from the article of clothing.

The user may then place a retaining clip on the opposite surface of the article of clothing, such as inside a shirt or jacket, and secure the insert member in the retaining portion of the retaining clip, with the material of the clothing extending therebetween.

The user may then don the item of clothing (where the previous actions were performed on a clothing item that was not already being worn) to place the fastener at the appropriate position. A counterpart fastener disposed on the case of a mobile device, such as a phone, may then be used to secure the mobile devices in the desired position. Where a suitable releasable adhesive is used, as discussed previously herein, no counterpart fastener may be present. Where necessary, the user may attach a counterpart fastener to the mobile device or its case.

For embodiments where the insert member is permanently attached to a mobile device case, the user may instead the insert member of the system on the exterior of an item of clothing, at a position that will correspond to a portion of the user's body which is easily accessible by a single hand when in a sitting position, with the mobile device case disposed on the insert member facing away from the article of clothing. The user may then place a retaining clip on the opposite surface of the article of clothing, such as inside a shirt or jacket, and secure the insert member in the retaining portion of the retaining clip, with the material of the clothing extending therebetween. The user may then don the item of clothing (where the previous actions were performed on a clothing item that was not already being worn) to place the mobile device case at the appropriate position.

Once the user is using the system to secure the mobile device at the appropriate position, the user may then utilize the mobile device when seated. For example, when receiving a call on a mobile phone secured using the device while horseback riding, the user may actuate the device to conduct a call using the speakerphone feature while keeping the user's hands free for holding the reins.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A system for removably securing a mobile device to an item of clothing worn by a user, comprising:
an insert member formed as a body having an upper surface, an opposite lower surface, and a surrounding sidewall extending between the upper surface and the lower surface;
a fastener disposed on the upper surface of the insert member;
a retaining clip comprising an open insert portion comprising a space for receiving the insert member which is defined by retaining sidewalls, wherein the retaining sidewalls contact the surrounding sidewall of the insert member when inserted to retain it therein.

2. The system of claim 1, wherein the surrounding sidewall of the insert member includes a recess and the retaining sidewalls defining the insert portion of the retaining clip are at least partially inserted into the recess to secure the insert member therein.

3. The system of claim 1, further comprising a counterpart fastener secured to a case of a mobile device, the counterpart fastener securable to the fastener disposed on the upper surface of the insert member.

4. The system of claim 1, wherein a case for a mobile device is secured to the fastener disposed on the upper surface of the insert member.

5. A method for removably securing a mobile device to a user's clothing for use while attached thereto, the method comprising:
positioning a lower surface of an insert member comprising the lower surface and a surrounding sidewall extending upwards from a perimeter thereof on an exterior of an article of clothing, wherein the article of clothing is formed from a pliable material;
positioning a retaining clip comprising an insert portion formed as a space for receiving the insert member which is defined by retaining sidewalls on an interior surface of the article of clothing opposite the insert member;
securing the insert member in the insert portion of the retaining clip, with the pliable material of the article of clothing extending therebetween; and
attaching a case of a mobile device to the insert member.

6. The method of claim 5, wherein attaching a case of a mobile device to the insert member comprises affixing an upper surface of the insert member to a case for a mobile device with a suitable adhesive.

7. The method of claim 5, wherein attaching a case of a mobile device to the insert member comprises affixing a fastener on a mobile device to a counterpart fastener on upper surface of the insert member.

8. The method of claim 7, wherein the fastener and counterpart fastener comprise hook and loop materials.

9. The method of claim 5, wherein positioning the lower surface of an insert member on an exterior of an article of clothing comprises positioning the lower surface of the insert member at a position on the article of clothing that corresponds to a portion of a user's body which is easily accessible by a single hand when in a sitting position.

10. The method of claim 9, wherein positioning the lower surface of the insert member at a position on the article of clothing that corresponds to a portion of a user's body which is easily accessible by a single hand when in a sitting position comprises positioning the lower surface of the insert member at a position on the article of clothing that corresponds to the front of user's shoulder.

11. The method of claim 5, wherein positioning the lower surface of an insert member on an exterior of an article of clothing comprises positioning the lower surface of an insert member on an exterior of a shirt or a jacket.

12. The method of claim 5, wherein positioning the lower surface of an insert member on an exterior of an article of clothing comprises positioning the lower surface of an insert member having a polygonal shape.

13. The method of claim 5, wherein securing the insert member in the insert portion of the retaining clip, with the pliable material of the article of clothing extending therebetween comprises inserting the retaining walls of the retaining clip into a recess formed in the surrounding sidewall of the insert member.

14. A method for securing a mobile device for use in a seated position, the method comprising:
positioning a lower surface of an insert member for attachment to a case of a mobile device on an exterior of an article of clothing formed from a pliable material at a position on the article of clothing that corresponds to a portion of a user's body which is easily accessible by a single hand when in a sitting position, wherein the insert member comprises a surrounding sidewall extending upwards from a perimeter of the lower surface;
positioning a retaining clip comprising an insert portion formed as a space for receiving the insert member which is defined by retaining sidewalls on an interior surface of the article of clothing opposite the insert member;
securing the insert member in the insert portion of the retaining clip, with the pliable material of the article of clothing extending therebetween; and
donning the article of clothing to position the secured insert member at the position on the user's body which is easily accessible by a single hand when in a sitting position.

15. The method of claim 14, wherein positioning a lower surface of an insert member for attachment to a case of a mobile device on an exterior of an article of clothing formed from a pliable material at a position on the article of clothing that corresponds to a portion of a user's body which is easily accessible by a single hand when in a sitting position comprises positioning the lower surface of the insert member at a position on the article of clothing that corresponds to the front of user's shoulder.

16. The method of claim 14, wherein positioning a lower surface of an insert member for attachment to a case of a mobile device on an exterior of an article of clothing formed from a pliable material at a position on the article of clothing that corresponds to a portion of a user's body which is easily accessible by a single hand when in a sitting position comprises positioning the lower surface of an insert member on an exterior of a shirt or a jacket.

17. The method of claim 14, further comprising attaching a case of a mobile device to the insert member.

18. The method of claim 17, wherein attaching a case of a mobile device to the insert member comprises affixing a fastener on the case of the mobile device to a counterpart fastener on upper surface of the insert member.

19. The method of claim 14, wherein positioning the lower surface of an insert member on an exterior of an article of clothing comprises positioning the lower surface of an insert member having a polygonal shape.

20. The method of claim 14, wherein securing the insert member in the insert portion of the retaining clip, with the pliable material of the article of clothing extending therebetween comprises inserting the retaining walls of the retaining clip into a recess formed in the surrounding sidewall of the insert member.
